(19) United States
(12) Patent Application Publication
(10) Pub. No.: US 2016/0328809 A1
(43) Pub. Date: Nov. 10, 2016

(54) METHOD AND DEVICE FOR THE PROVISION OF AGGREGATE OFFERS OF ELECTRICAL ENERGY

(71) Applicant: Schneider Electric Industries SAS, Rueil-Malmaison (FR)

(72) Inventors: Bernard LEBEAU, Les Adrets (FR); Jeremie MARCHAND, Four (FR)

(73) Assignee: Schneider Electric Industries SAS, Rueil-Malmaison (FR)

(21) Appl. No.: 15/096,490

(22) Filed: Apr. 12, 2016

(30) Foreign Application Priority Data
May 5, 2015 (FR) 15 54034

(51) Int. Cl. G06Q 50/06; H02J 3/28; G05B 13/02; G06Q 40/04

(52) U.S. Cl. CPC G06Q 50/06; G06Q 40/04; H02J 3/28; G05B 13/021

(57) ABSTRACT

There are provided a method and a device for providing aggregate offers of electrical energy, on the basis of a plurality of loads and/or of sources of customer sites of an electrical network, the method including the reception of information relating to a provision of electrical power arising from the loads and/or sources of each customer site, and the determination of elementary blocks of electrical power, each elementary block being defined in two dimensions by a duration and an electrical power, followed by a spatial arranging of elementary blocks to obtain an aggregate block defined by an electrical power and a duration complying with a constraint selected from among a setpoint power or a setpoint duration, the spatial arranging step implementing a procedure for optimizing spatial filling of a block defined by a maximum power and a maximum duration, by elementary blocks.

The present invention relates to a method for providing an aggregate offer of electrical energy for a predetermined time interval on the basis of a plurality of customer sites of an electrical network. It also relates to an associated device.

The invention lies in the field of intelligent electrical networks for contributing to the balancing of electricity production-consumption.

In a known manner, in so-called intelligent electrical networks, the customer sites, belonging to end users, are induced to be contributors to the balancing of the electrical network.

The balancing of the electrical network requires a permanent guarantee of perfect equality between production and consumption so as to avoid black-outs regardless of events and situations such as extreme weather conditions, sudden loss of a production station, poor forecast of consumption.

Various known procedures exist for electrical network regulation, such as producer addition or removal, stoppage of consumption of big consumers.

Latterly, customer sites may also comprise producers or sources of electrical energy, for example solar panels, wind turbines, and electrical energy storage means (for example electric-generating plants or batteries).

Thus, customer sites are capable of proposing to the players in the electrical network a contribution to the balancing of the electrical network by reducing or by consuming on demand and thus receiving financial compensation according to established rules of the network balancing mechanisms. The players in the electrical network comprise the energy consumers-producers, the manager of the electrical network, the energy transporter or transporters.

However, it is expensive in terms of time and complexity to individually process the offers of electrical energy of the customer sites, these customer sites typically having highly variable capacities, according to the number of loads present and the possible presence of sources of electrical energy.

It is therefore useful to have an aggregation platform, capable of aggregating the offers of provision of electrical power originating from several customer sites, over a given period, as a function of the forecasts of non-consumption and/or of electrical production of these customer sites, so as to provide a meaningful offer to a player in the electrical network.

The invention lies more particularly within this context and its objective is to propose a method and a device for providing aggregate offers of electrical energy.

For this purpose, the invention proposes, according to a first aspect, a method for providing aggregate offers of electrical energy, each offer of electrical energy being defined by a power and a duration in a predetermined time interval, on the basis of a plurality of loads and/or of sources of customer sites of an electrical network, each customer site being able, for the predetermined time interval, to propose at least one elementary offer of reduction or provision of electrical power having an associated duration, corresponding to a reduction in electrical power consumption of a load of the site or to a provision of electrical energy by an electrical energy source of the site. The method comprises the steps of:
reception of information relating to a provision of electrical power arising from the loads and/or sources of each customer site, and determination, for each customer site, of at least one elementary block of electrical power, each elementary block of power being defined in two dimensions by an associated duration and an associated electrical power;
spatial arrangement of elementary power blocks to obtain an aggregate block defined by an electrical power and a duration, the said electrical power and/or the said duration of the aggregate block complying with a constraint selected from among a setpoint power or a setpoint duration, the spatial arrangement step implementing a procedure for optimizing spatial filling of a block, defined by a maximum power and a maximum duration, by elementary blocks.

Advantageously, the method of the invention implements a spatial filling optimization procedure for a spatial arrangement of the elementary blocks of electrical power, resulting in the determination of an aggregate offer of electrical energy in an effective and optimized manner with respect to the multiple elementary offers originating from the various customer sites. Optimization of the spatial filling has the advantage of minimizing the deficits of provision of electrical energy in the aggregate block thus formed, these deficits corresponding to the unfilled surface areas or “holes” of the spatial arrangement.

The method for providing aggregate offers of electrical energy according to the invention can also exhibit one or more of the features hereinbelow, taken in isolation or according to all the technically possible combinations.

The spatial filling optimization procedure is a filling procedure based on power levels of decreasing height, the height of each power level corresponding to the maximum power of an elementary block belonging to the said power level.

The method comprises, prior to the implementation of the spatial filling optimization procedure, a step of classing the said elementary blocks by decreasing power.

The spatial filling optimization procedure is modified to permit an overshoot according to at least one of the dimensions of maximum duration or of maximum power of the block to be filled.

The method furthermore comprises a step of adjusting the aggregate block by rejecting an elementary block overshooting the duration of the aggregate block, the overshoot of duration of the said elementary block being greater than or equal to a predetermined percentage of the duration of the said elementary block.

The method comprises, after the implementation of the spatial filling optimization procedure, a step of rearrangement and/or re-slicing to obtain an aggregate block as a function of the selected constraint.

The spatial arrangement of elementary blocks implements a plurality of power levels, arranged as a function of their height, and the method comprises a step of searching for a power level whose associated power is the closest to the setpoint power value.

The method comprises a step of minimizing a deficit of power of the aggregate block, comprising a progressive decreasing of the duration of the aggregate block until the unfilled surface area of the said aggregate block is less than or equal to a predetermined percentage of the total surface area of the aggregate block, making it possible to ensure a degree of power deficit of less than a predetermined value.

The spatial arrangement of elementary blocks implements a plurality of power levels, arranged as a function of their height, and the method comprises a step of calculating a degree of power deficit per power level, equal to a degree of unfilled surface area of the said power level, and a rearrangement of the power levels in an increasing order of the degree of power deficit per power level.

The method comprises, after the rearrangement of the power levels, a determination of the highest power level for which a quality criterion relating to the total deficit of power is complied with.

The method comprises, furthermore, a step of determining at least one power level complying with a criterion of proximity with respect to the setpoint power, and a selection of a power of the said aggregate block complying with both the said criterion of proximity with respect to the setpoint power and the said quality criterion relating to the total deficit of power.

The quality criterion relating to the total deficit of power imposes a degree of power deficit of the aggregate block of less than or equal to a predetermined value.

The method comprises a step of updating the determined aggregate block, repeated at regular temporal instants.

According to a second aspect, the invention relates to a device for providing aggregate offers of electrical energy, each offer of electrical energy being defined by a power and a duration in a predetermined time interval, on the basis of a plurality of loads and/or of sources of customer sites of an electrical network, each customer site being able, for the predetermined time interval, to propose at least one elementary offer of reduction or provision of electrical power having an associated duration, corresponding to a reduction in electrical power consumption of a load of the site or to a provision of electrical energy by an electrical energy source of the site. The device comprises means suitable for:
receiving information relating to a provision of electrical power arising from the loads and/or sources of each customer site, and determining, for each customer site, at least one elementary block of electrical power, each elementary block of power being defined in two dimensions by an associated duration and an associated electrical power;
performing a spatial arrangement of elementary power blocks to obtain an aggregate block defined by an electrical power and a duration, the said electrical power and/or the said duration of the aggregate block complying with a constraint selected from among a setpoint power or a setpoint duration, the spatial arrangement implementing a procedure for optimizing spatial filling of a block, defined by a maximum power and a maximum duration, by elementary blocks.

According to a feature, the electrical power and the duration of the aggregate block are determined so as to comply with a quality criterion relating to a total deficit of power of the aggregate block.

Furthermore, the device for providing aggregate offers of electrical energy comprises means for the implementation of the method for providing aggregate offers of electrical energy according to all the features briefly described hereinabove.

Other features and advantages of the invention will emerge from the description which is given thereof hereinbelow, by way of wholly nonlimiting indication, with reference to the appended figures, among which:

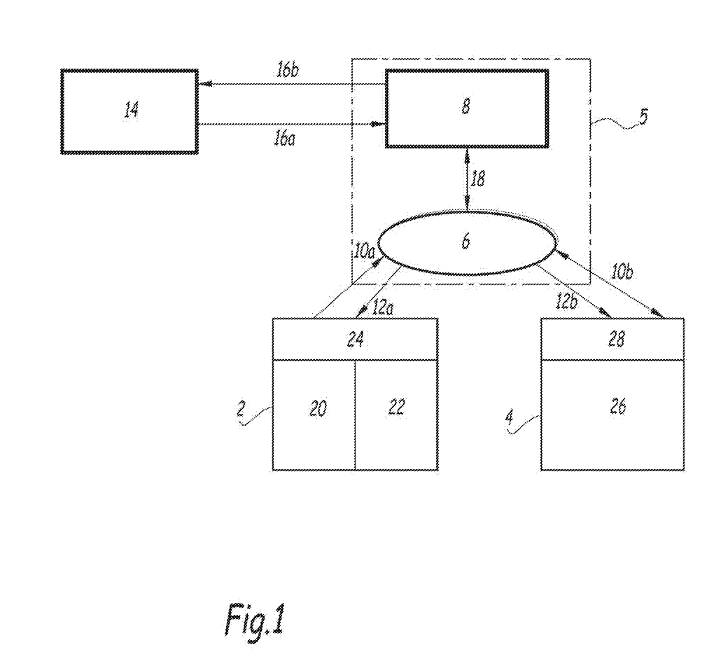

FIG. 1 schematically represents a system for communication between producers-consumers and systems for piloting the electrical network;

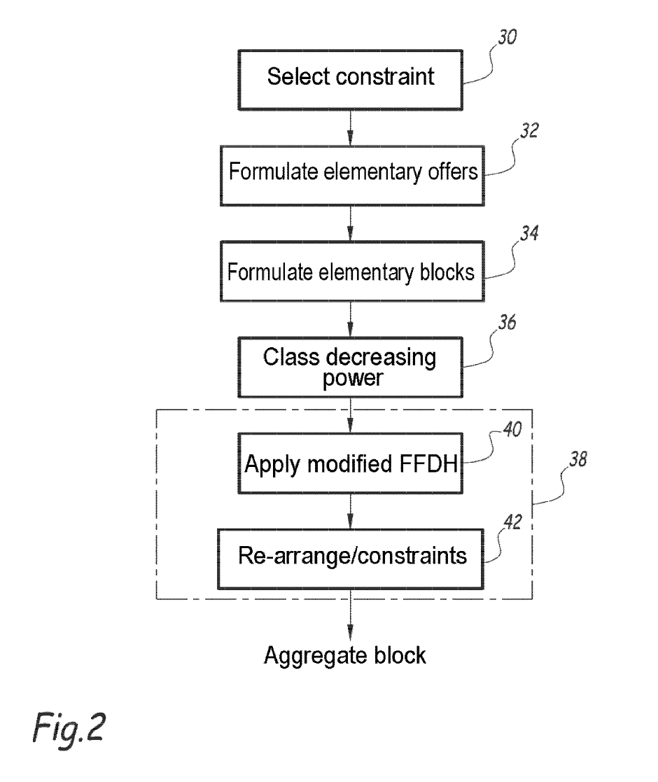

FIG. 2 is a schematic of the main steps of a method for providing an aggregate offer of electrical energy for a predetermined time interval according to an embodiment of the invention;

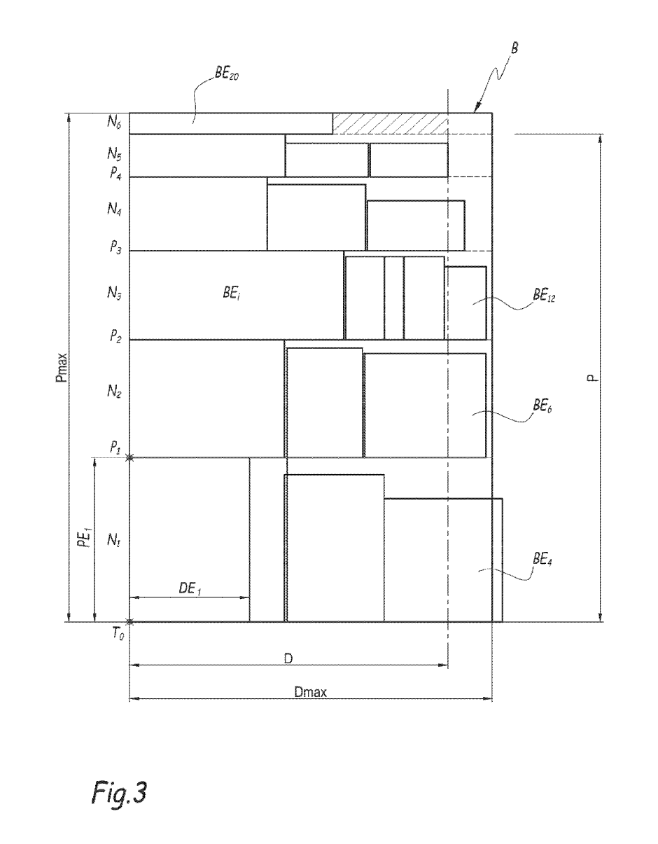

FIG. 3 is a schematic example of aggregate block obtained;

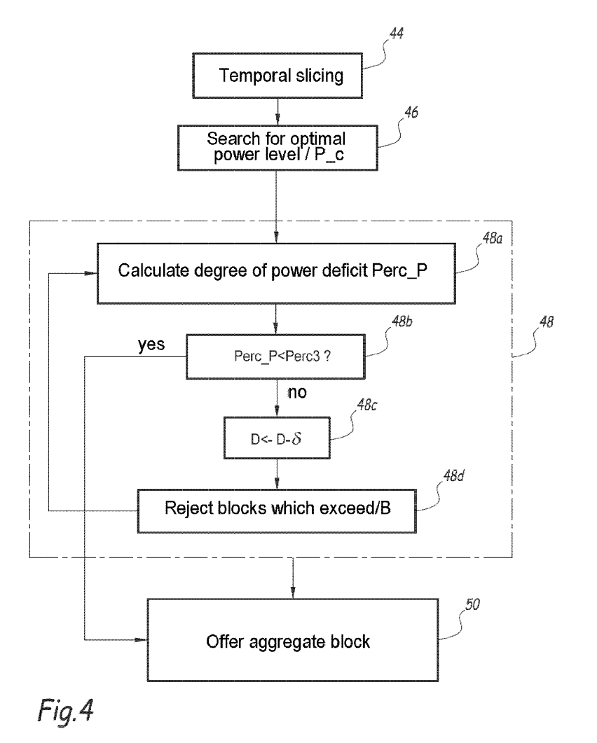

FIG. 4 illustrates the steps of a first implementation variant corresponding to a first constraint to be complied with;

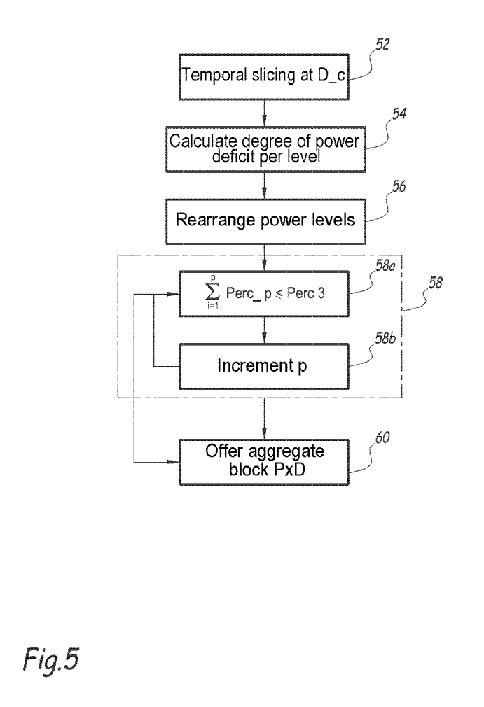

FIG. 5 illustrates the steps of a second implementation variant corresponding to a second constraint to be complied with;

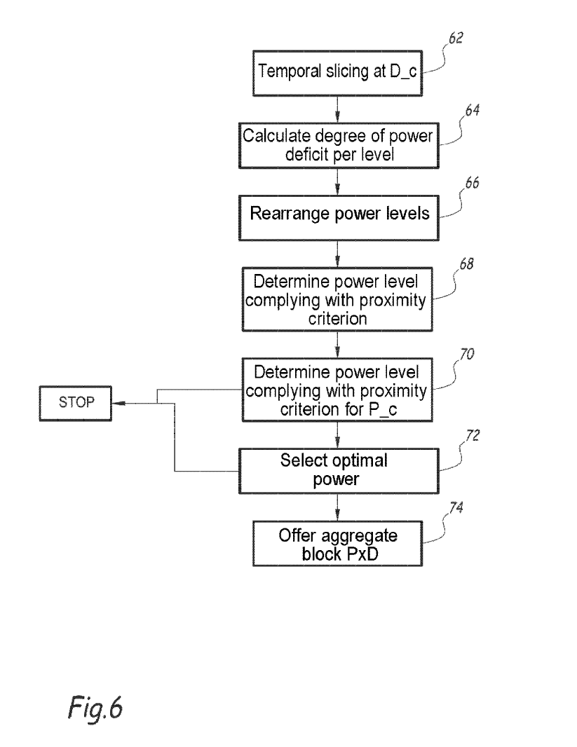

FIG. 6 illustrates the steps of a third implementation variant corresponding to a third constraint to be complied with;

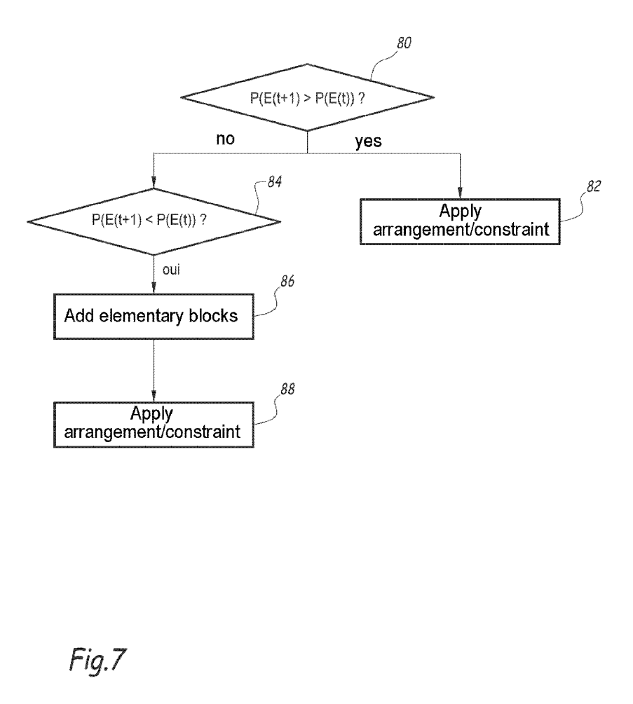

FIG. 7 is a schematic of the main steps of an updating of the aggregate offer of electrical energy according to an embodiment of the invention.

The invention will be described hereinafter within the framework of an electrical network.

FIG. 1 schematically represents a system 1 for communication of the electricity consumer-producer customer sites with the systems for piloting the electrical network, comprising a plurality of customer sites 2, 4, an energy services platform 5, comprising a collection and optimization platform 6 and an aggregation platform 8. The energy services platform 5 is in communication with an aggregator information system 14.

Each electricity producer-consumer customer site 2, 4 comprises a local controller and an interface 24 and 28, and loads and/or sources of electrical energy 20, 22, 26, simply called sources hereinafter, as described in greater detail hereinafter.

Only two customer sites 2, 4 are illustrated so as to facilitate the explanation, but the invention evidently applies to any number of customer sites.

The collection and optimization platform 6 comprises communication means, for example wireless communication means, serving as interface between the customer sites 2, 4 and the aggregation platform 8.

The collection and optimization platform 6 is able to receive data containing elementary information 10a, 10b in respect of provision of electrical power on the part of the customer sites, and to return to the customer sites orders for piloting 12a, 12b the loads and sources as a function of requests for provision of elementary power or reduction of power, originating from the aggregation platform 8.

Moreover, the platform 6 calculates elementary offers of power, on the basis of meteorological data or of measurements arising from the customer sites and archived by the platform.

Moreover, the collection and optimization platform 6 is able to exchange information 18 with the aggregation platform 8, in particular to dispatch to the aggregation platform the calculated elementary offers of electrical power and to receive from the aggregation platform 8 orders for power reduction or for power provision.

The various information is exchanged in the form of formatted messages according to a communication protocol in a predefined electrical network.

The aggregator 14 communicates with the energy services platform 5 by using the OPENADR (for “Open Automated Demand Response”) protocol.

The platform 6 communicates with the customer sites 2, 4, either by way of the OPENADR protocol, or by way of a proprietary protocol.

Between the collection and optimization platform 6 and the aggregation platform 8 the exchanges are made by communications of Webservices type.

The aggregation platform 8 is able to communicate with the aggregator information system 14 of the electrical network, called the aggregator subsequently.

For example, the aggregator requests, via a message 16a, offers of reduction or increase of power P_c and of duration D_c, which are respectively the power setpoint and duration setpoint, over a predetermined time period, for example for the next 24 h.

In response, the aggregation platform 8 calculates and dispatches to the aggregator 14 offers 16b of electrical power, corresponding to an aggregation of elementary offers of electrical power calculated on the basis of the provision capacities of the customer sites 2, 4.

The aggregator 14 has the possibility of accepting or of refusing an offer 16b provided by the aggregation platform 8. In case of acceptance, the aggregation platform 8 and the collection and optimization platform 6 disaggregate the accepted offer 16b into elementary offers, and the collection and optimization platform 6 transmits the corresponding orders for power provision and/or reduction to the customer sites.

In the example of FIG. 1, the electrical installation of the customer site 2 comprises loads 20, sources of electrical energy 22, and an interface 24, able to receive the orders for piloting 12a of the collection and optimization platform 6 and to transform them into effective orders for piloting of the local loads 20 and sources of electrical energy 22.

For example, the loads form part of an air-conditioning and heating system, also known by the acronym HVAC pour Heating Ventilation and Air Conditioning. The interface 24 is able to pilot the HVAC loads either directly, or through a BMS (“Building Management System”) piloting module.

The electrical energy source 22 is for example an energy storage system, for example an electric-generating plant, or a set of batteries able to store the electrical energy. In this case, the associated piloting module is a programmable logic controller (PLC).

In the example illustrated in FIG. 1, the customer site 4 comprises only a set of electric loads 26, piloted by the interface 28.

The collection and optimization platform 6 is able to estimate the elementary offers of power provision according to a plan for optimizing the sources and loads (consumption/production) which are available during a part of a predetermined time period T, for example in the 24 hours following a start time T₀ corresponding to the date at which the forecast calculation is performed.

More generally, the predetermined time period T is a parameter whose value is arbitrary, and is fixed according to spot needs.

For example, in the case of loads of an air-conditioning and heating system, parameters such as the occupancy schedule of premises, the temperature setpoints, the forecast of exterior temperature and sunshine, the thermal model of the building and the tariff schedule are used.

On the basis of the forecast curves of consumption/production load, it is possible to determine operating margins of the loads, to identify reductions in electrical energy consumption and estimations of production for the time period T considered, and to deduce therefrom, for each source or load of the customer site, one or more elementary offers of electrical power provision.

Each elementary power provision offer is defined by a power Pₑ and a duration Dₑ, and is valid in a predetermined time interval Iₑ, this time interval Iₑ lying within the predetermined time period T for which the forecast calculation is performed.

For example, a load such as an HVAC installation can be stopped between 9 o'clock and 10 o'clock in the morning, for a given consumed energy reduction during this hour.

The aggregation platform 8 can produce one or more aggregate offers of power provision-reduction or stimulation, after the collection and optimization platform 6 has calculated elementary offers of power reduction or stimulation which arise from the information 10a, 10b.

The aggregation platform 8 is able to formulate one or more aggregate offers of electrical energy, complying at least with the setpoint power P_c or the setpoint duration D_c, for example a power of the order of several hundreds of kilowatts kW for an hour, or indeed of a MegaWatt, for 1 hour, and thereafter propose these aggregate offers of electrical energy to the aggregator 14.

Thus, the energy services platform 5 has a role of intermediary between the customer sites 2, 4 and the aggregator 14.

Advantageously, the offers of electrical power of the customer sites have a better rating on account of their being grouped together, thereby allowing the customer sites and therefore the end consumers to accord them a better financial rating.

Moreover, the management of the electrical network gains in terms of flexibility, the redistribution of the electrical powers not consumed or produced by the customer sites making it possible to improve the management capacity in case of global overload of the electrical network, for example in peak periods in case of heavy electrical overconsumption.

FIG. 2 shows the main steps of a method for providing an aggregate offer of electrical energy in an embodiment of the invention.

The method is implemented by a device for providing an aggregate offer of electrical energy, implemented by the energy services platform 5, comprising digital calculation means, for example one or more processors, as well as associated memories.

During a first step 30 of selecting a constraint, a constraint to be complied with is selected, from among the following variants: (a) compliance with the setpoint power P_c and with a quality criterion, (b) compliance with the setpoint duration D_c and with a quality criterion, (c) compliance both with the setpoint power P_c and with the setpoint duration D_c, and also with a quality criterion.

During a step 32 of formulating elementary offers of power, elementary offers of electrical power provision are formulated as a function of the information originating from customer sites.

Optionally, during this step 32 of formulating elementary offers, a selection of the elementary offers of electrical power provision is implemented, as a function of one or more criteria such as:
the availability of the offer during a fraction of the predetermined time period
the number of recent contributions of the customer site or of the loads proposing the offer, thus making it possible to distribute the contribution of the various customer sites, for example by a system for counting the number of contributions over a sliding temporal period,
the location of the customer site from which the offer originates, so as to select the offers geographically closest to the part of the network to be saved,
the type of power provision offer or the type of electrical energy, thus making it possible for example to favour ecological energy sources.

As a variant, the step of formulating the power offers is performed prior to the aggregation method implementation, and step 32 becomes a step of retrieving the power offers.

Thereafter, a step 34 of representing the offers of provision of electrical power, which are received or retained during the step of formulating or retrieving elementary offers 32, by two-dimensional elementary blocks of electrical energy BEᵢ, hereinafter called elementary blocks, each elementary block BE; being defined by a duration DEᵢ and an associated electrical power PEᵢ.

The elementary blocks are sorted in order of decreasing power during a sorting step 36.

The elementary blocks BE are thereafter arranged by a procedure for optimized spatial filling during a step of spatial arrangement 38.

An aggregate block is obtained, with dimensions power P and duration D, complying with the constraint selected in step 30.

The step of optimized spatial arrangement 38 comprises a sub-step 40 of applying a modified procedure for spatial arrangement so as to permit overshoots with respect to the dimensions of the initial container, which is a maximum block with dimensions maximum power Pₘₐₓ, maximum duration Dₘₐₓ.

Preferably, a spatial filling procedure chosen in the class of procedures called “Bin packing” is used.

In one embodiment, a modified FFDH (“First-Fit Decreasing Height”) algorithm is applied.

This type of procedure is known in the field of the optimized spatial arranging of objects in containers of predetermined dimensions, making it possible to minimize the unfilled surface areas or holes, which correspond, in the present case, to deficits of provision of electrical energy.

In the preferred embodiment, for the application of the FFDH algorithm, the power dimension is the height of the elementary blocks. The arranging of the elementary blocks is done without rotation, so as to comply with the respective dimensions associated with the power (height of an elementary block) and with the duration (width of an elementary block).

Step 40 comprises an arranging of the elementary blocks by successive power levels, each power level corresponding to a “stage” of the spatial arrangement.

The maximum container or block has initial dimensions Dₘₐₓ, Pₘₐₓ, greater than or equal to the setpoint values.

However, in contradistinction to a conventional “Bin packing” spatial arrangement algorithm, an overshoot in the horizontal dimension, corresponding to the duration of each power level, is permitted.

If an elementary block exceeds Dₘₐₓ by more than a percentage Perc1 of its own duration, preferably equal to 50%, then the elementary block is rejected and another elementary block, in the order obtained after the sorting step 36, is considered.

The spatial filling step 40 is followed by a step 42 of rearrangement and/or re-slicing as a function of the chosen constraint.

Several embodiments of the step of rearrangement and/or re-slicing 42 are envisaged, as explained hereinafter.

On exiting the step of optimized spatial arrangement 38, an aggregate block B of maximum power P and of duration D is obtained, as illustrated by an example in FIG. 3.

In this example, the aggregate block B comprises a plurality of elementary blocks BEᵢ, arranged by levels N₁ to N₆ of decreasing height, the height corresponding to the power. The maximum power of the power level Nᵢ is denoted Pᵢ.

For example, in FIG. 3, the first power level N₁ has a height equal to PE₁ which is the maximum height of the elementary blocks of the level.

As may be seen in FIG. 3, the aggregate block B obtained has a total surface area P×D and comprises surface areas that are not filled, or power “holes”, each unfilled surface area corresponding to a deficit of provided power.

Thus, certain power levels may exhibit a power deficit, equal to the surface area of the “holes” present in the power level.

The total deficit of power in the aggregate block is equal to the sum of the power deficits for the respective power levels.

The power level actually provided, corresponding to an effective electrical power P_{effective} which can be provided by the whole set of aggregate elementary blocks for the duration Dₘₐₓ is, in the general case, less than or equal to the maximum power level corresponding to the maximum electrical power Pₘₐₓ.

Advantageously, a quality criterion is defined which limits the power deficit to a percentage Perc3 of the total power not to be exceeded. Preferably, Perc3=5%. Any percentage, between 0 and 100%, can be envisaged.

According to a first variant, the constraint to be complied with imposes compliance with the setpoint power P_c and with the quality criterion relating to the limitation of the power deficit defined hereinabove, compliance with the duration setpoint D_c not being a priority.

The step 42 of rearrangement and/or re-slicing as a function of the constraint chosen according to this first variant comprises the sub-steps illustrated schematically in FIG. 4.

During a first step 44 of temporal slicing, the elementary blocks which exceed Dₘₐₓ are temporally re-sectioned so as to obtain an aggregate block of duration Dₘₐₓ.

In this embodiment, Dₘₐₓ=D_c.

Thereafter, a power level corresponding to the setpoint power P_c is searched for in the step 46 of searching for an optimal power level.

The blocks of the power level Nₗ have a maximum power amplitude equal to When the setpoint power P_c lies between Pₗ₋₁ and Pₗ, the power level closest to P_c is retained in the following manner:

If (Pₗ₋₁+Pₗ)/2≦P_c≦Pₗ then the power level Nₗ is kept, P=Pₗ.

If Pₗ₋₁≦P_c<(Pₗ₋₁+Pₗ)/2 then the power level Nₗ₋₁ is kept, P=Pₗ₋₁.

The power associated with the level retained is the power of the aggregate block on exit from the step 46 of searching for an optimal power level.

Thus, on exit from step 46, the aggregate block has a power P and a duration Dₘₐₓ.

Step 46 is followed by a step 48 of minimizing the power deficit.

During this step, satisfaction of the quality criterion is ensured.

At the outset, the duration of the aggregate block is D=Dₘₐₓ.

During step 48, the degree of power deficit of the aggregate block, denoted Perc_P, is calculated (sub-step 48a), and if this deficit does not satisfy the quality criterion defined by the maximum percentage of deficit Perc3 (verification of sub-step 48b), the duration of the block is reduced by a quantity δ, for example δ=1 minute (sub-step 48c).

According to one embodiment, for a given duration D, the degree of power deficit is calculated for each power level and added together to verify the satisfaction or otherwise of the criterion.

Moreover, after having decremented the duration D, a check verifies (sub-step 48d) whether an elementary block exceeds D by more than a percentage Perc1 of its own duration, preferably Perc1=50%. In case of positive verification, the elementary block is rejected and replaced with another elementary block.

Sub-steps 48a to 48d are repeated until the quality criterion is satisfied, for a duration D.

On exit, an aggregate block of maximum power P and of duration D is obtained, the power P corresponding to the power level closest to the setpoint power P_c, and the duration D possibly being less than the setpoint duration D_c, it nonetheless being ensured that the aggregate block satisfies the criterion of limiting the deficit of power to a percentage less than or equal to Perc3 with respect to the power P.

An offer consisting of an aggregate block of dimensions P×D is issued during the offer issuing step 50.

According to a second variant, the constraint to be complied with imposes compliance with the power of duration D_c and with the quality criterion defined hereinabove, compliance with the power setpoint P_c not being a priority.

The step 42 of rearrangement and/or re-slicing as a function of the constraint chosen according to this second variant comprises the sub-steps illustrated schematically in FIG. 5.

During a first step of temporal slicing 52, the elementary blocks which exceed D_c are temporally re-sectioned so as to obtain an aggregate block of duration D_c. The duration D_c of the aggregate block is not modified subsequently, therefore D=D_c for the aggregate block.

Thereafter, during a step 54 of calculating power deficit, the degree of power deficit Perc_i is calculated for each power level Nᵢ.

Thereafter, during a step 56 of rearranging the power levels, the power levels are sorted by increasing degree of power deficit, the aggregate block obtained by aggregation of the power level or levels comprising the least deficit up to the power levels comprising the most power deficit.

On exit from step 56, an aggregate block with dimensions power Pₘₐₓ and duration D_c is obtained.

Finally, during a following step 58, a search is conducted for the power P, corresponding to the highest power level N of the aggregate block obtained in step 56 for which the power deficit criterion is satisfied.

During a verification sub-step 58a, starting from p=1, we verify the quality criterion:

$${\sum }_{i = 1}^{p} Perc\_p \leq Perc 3$$

In case of positive verification, we retain N=Nₚ and we increment p p=p+1 during a sub-step 58b, and return to the verification 58a.

The loop stops when a power level N_{L+1} is reached for which the sum of the degrees of deficit exceeds Perc3.

The last power level N_{L} for which the quality criterion is complied with has thus been obtained. The maximum power of this power level N_{L} is the power P_{L} of the final aggregate block.

The final aggregate block has dimensions power P=P_{L}, and duration D=D_c. During step 60, an offer consisting of an aggregate block of dimensions P×D is issued.

According to a third variant, the constraint to be complied with imposes the compliance both with the setpoint power P_c and with the setpoint duration D_c, and also with a quality criterion.

Step 42 of rearrangement and/or re-slicing as a function of the constraint chosen according to this third variant comprises the sub-steps illustrated schematically in FIG. 6.

During a first step 62, the elementary blocks which exceed D_c are temporally re-sectioned so as to obtain an aggregate block of duration D_c.

Thereafter, during a step 64 of calculating power deficit, the degree of power deficit Perc_i is calculated for each power level Nᵢ.

Thereafter, during a step 66 of rearranging the power levels, analogous to step 56 described previously, the power levels are sorted by increasing degree of power deficit.

On exit from step 66, an aggregate block with dimensions power Pₘₐₓ and duration D_c is obtained.

During a following step 68, analogous to step 58 described previously, a search is conducted for the power level P_{L}, corresponding to the highest power level N_{L} of the aggregate block obtained in step 66 for which the power deficit criterion is satisfied.

In step 70, a search is conducted for the power level or levels, among the levels retained, whose power satisfies a criterion of proximity with respect to the setpoint power P_c given by:

|Pᵢ−P_c|≦Perc2×P_c

With Perc2 preferably equal to 10%.

If no power level satisfies this relation, then the method ends without issuing an aggregate offer.

If at least one level Nᵢ of power Pᵢ corresponds, a check in the optimal power selection step 72 verifies whether Pᵢ≧P_c, and in case of positive verification, the final power of the aggregate block P=Pᵢ is retained.

If Pᵢ<P_c, a search is conducted, among the power levels greater than Nₗ, for whether there exists a power level greater than or equal to P_c which satisfies the quality criterion and the proximity criterion.

If such a power level N_{q} of power P_{q} is found, then P=P_{q} is the power retained for the final aggregate block.

During step 74, an offer consisting of an aggregate block of dimensions P×D is issued, the duration D being equal to the duration D_c and the power P being the power of the power level selected during step 72 as explained hereinabove.

If no power level satisfying the criteria is found, then the method ends without issuing an aggregate offer.

As a variant, the duration of the aggregate block is also adjusted within a certain margin to seek to validate the quality criterion.

Thus, by virtue of the aggregation, the device according to the invention is able to group together the offers of several customer sites and to transmit an offer of energy of sufficient power to the aggregator 14, whereas the elementary offers of electrical power provision that are transmitted by the customer sites separately do not meet the constraints imposed by the aggregator.

The aggregate offer of provision of an elementary block of electrical energy arises from the flexibility associated with the forecasts of electrical energy production/consumption by the customer sites for a predetermined time period T, for example for a period of 24 hours from a given date T₀.

However, the forecasts of production/consumption per customer site may undergo modifications in the course of the target predetermined time period T, for example on account of changes in operating conditions such as meteorological changes for an air-conditioning and heating system, or for an energy source comprising photovoltaic panels.

It is useful to validate and modify if appropriate the aggregate offer of electrical energy, at regular time intervals, for example every hour for a predetermined time period T of 24 hours.

In case of acceptation of the aggregate block offer it is useful to reajust the content of the aggregate block so as to guarantee the contracted power P_c and contracted duration D_c.

The offers change with the meteorological conditions and may undergo an erosion in power; it is therefore necessary to reajust them regularly so as to be able to comply with the agreed contract.

FIG. 7 presents a schematic of the main steps of an updating of the aggregate offer of electrical energy according to an embodiment of the invention, this updating step being performed at regular time intervals, for example every 15 minutes.

During a first comparison step 80, the effective electrical power provided at a future temporal instant t+1 by the aggregate block, denoted P(E(t+1)), is compared with the effective electrical power P(E(t)) provided at a current temporal instant t.

If the power P(E(t+1)) is greater than P(Et( ), then the power is adjusted to meet the constraint previously selected, according to one of the variants described above, during a step 82. It should be noted that certain elementary blocks retained at the temporal instant t are not necessarily still retained at the temporal instant t+1.

If the power P(E(t+1)) is less than or equal to the power P(E(t)), then a check verifies during a step 84 whether the power P(E(t+1)) is strictly less than P(E(t)).

In case of negative response in step 84, it is deduced therefrom that the effective powers at the respective instants t and t+1 are equal, therefore no action is necessary.

In case of positive response in step 84, therefore if the power P(E(t+1)) is strictly less than P(E(t)), step 84 is followed by a step 86 of adding elementary blocks.

The previously defined elementary blocks are kept so as to avoid modifications to the usage schedules of the loads of the sites. Other elementary blocks are selected to make up the power deficit with respect to the desired power, for the duration D_c.

Thereafter, one of the previously described variants is applied to step 88, so as to comply with the previously selected constraint.

1. A method for providing aggregate offers of electrical energy, each offer of electrical energy being defined by a power and a duration in a predetermined time interval, on the basis of a plurality of loads and/or of sources of customer sites of an electrical network, each customer site being able, for the predetermined time interval, to propose at least one elementary offer of reduction or provision of electrical power having an associated duration, corresponding to a reduction in electrical power consumption of a load of the site or to a provision of electrical energy by an electrical energy source of the site, the method comprising:
reception of information relating to a provision of electrical power arising from the loads and/or sources of each customer site, and determination for each customer site, of at least one elementary block of electrical power, each elementary block (BEᵢ) of power being defined in two dimensions by an associated duration (DEi) and an associated electrical power (PEᵢ); and
spatial arrangement of elementary power blocks to obtain an aggregate block defined by an electrical power (P) and a duration (D), the electrical power and/or the duration of the aggregate block complying with a constraint selected from among a setpoint power (P_c) or a setpoint duration (D_c),
the spatial arrangement step implementing a procedure for optimizing spatial filling of a block, defined by a maximum power (Pₘₐₓ) and a maximum duration (Dₘₐₓ), by elementary blocks.

2. The method according to claim 1, wherein the spatial filling optimization procedure is a filling procedure based on power levels of decreasing height, the height of each power level corresponding to the power of an elementary block belonging to the power level.

3. The method according to claim 2, comprising, prior to the implementation of the spatial filling optimization procedure, the elementary blocks by decreasing power.

4. The method according to claim 1, wherein the spatial filling optimization procedure is modified to permit an overshoot according to at least one of the dimensions of maximum duration (Dₘₐₓ) or of maximum power (Pₘₐₓ) of the block to be filled.

5. The method according to claim 4, further comprising a step of adjusting the aggregate block by rejecting an elementary block overshooting the duration (D) of the aggregate block, the overshoot of duration of the elementary block being greater than or equal to a predetermined percentage of the duration of the elementary block.

6. The method according to claim 1, comprising, after the implementation of the spatial filling optimization procedure, a step of rearrangement and/or re-slicing to obtain an aggregate block as a function of the selected constraint.

7. The method according to claim 6, in which the spatial arrangement of elementary blocks implements a plurality of power levels, arranged as a function of their height, comprising a step of searching for a power level whose associated power is the closest to the setpoint power value (P_c).

8. The method according to claim 7, comprising a step of minimizing a deficit of power of the aggregate block, comprising a progressive decreasing of the duration (D) of the aggregate block until the unfilled surface area of the aggregate block is less than or equal to a predetermined percentage of the total surface area of the aggregate block, making it possible to ensure a degree of power deficit of less than a predetermined value.

9. The method according to claim 6, in which the spatial arrangement of elementary blocks implements a plurality of power levels, arranged as a function of their height, comprising a step of calculating a degree of power deficit per power level, equal to a degree of unfilled surface area of the power level, and a rearrangement of the power levels in an increasing order of the degree of power deficit per power level.

10. The method according to claim 9, comprising, after the rearrangement of the power levels, a determination of the highest power level for which a quality criterion relating to the total deficit of power is complied with.

11. The method according to claim 10, further comprising determining at least one power level complying with a criterion of proximity with respect to the setpoint power (P_c), and a selection of a power of the aggregate block complying with both the criterion of proximity with respect to the setpoint power and the quality criterion relating to the total deficit of power.

12. The method according to claim 10, wherein the quality criterion relating to the total deficit of power imposes a degree of power deficit of the aggregate block of less than or equal to a predetermined value.

13. The method according to claim 1, further comprising updating the determined aggregate block, repeated at regular temporal instants.

14. A device for providing aggregate offers of electrical energy, each offer of electrical energy being defined by a power and a duration in a predetermined time interval, on the basis of a plurality of loads and/or of sources of customer sites of an electrical network, each customer site being able, for the predetermined time interval, to propose at least one elementary offer of reduction or provision of electrical power having an associated duration, corresponding to a reduction in electrical power consumption of a load of the site or to a provision of electrical energy by an electrical energy source of the site, comprising means configured for:
receiving information relating to a provision of electrical power arising from the loads and/or sources of each customer site, and determining, for each customer site, at least one elementary block of electrical power, each elementary block (BEᵢ) of power being defined in two dimensions by an associated duration (DEᵢ) and an associated electrical power (PEᵢ);
performing a spatial arrangement of elementary power blocks to obtain an aggregate block defined by an electrical power (P) and a duration (D), the electrical power and/or the duration of the aggregate block complying with a constraint selected from among a setpoint power (P_c) or a setpoint duration (D_c), the spatial arrangement implementing a procedure for optimizing spatial filling of a block, defined by a maximum power (Pₘₐₓ) and a maximum duration (Dₘₐₓ), by elementary blocks.

15. The device for providing aggregate offers of electrical energy according to claim 14, wherein the electrical power (P) and the duration (D) of the aggregate block are determined so as to comply with a quality criterion relating to a total deficit of power of the aggregate block.
